(19) United States
(12) Patent Application Publication
(10) Pub. No.: US 2009/0083317 A1
(43) Pub. Date: Mar. 26, 2009

(54) FILE SYSTEM, DATA PROCESSING APPARATUS, FILE REFERENCE METHOD, AND STORAGE MEDIUM

(75) Inventor: Toshio Yoshihara, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/212,383

(22) Filed: Sep. 17, 2008

(30) Foreign Application Priority Data
Sep. 21, 2007 (JP) 2007-245214

(51) Int. Cl. G06F 17/30

(52) U.S. Cl. 707/103 R; 707/E17.01

(57) ABSTRACT

A file system which is reduced in time taken to refer to a file stored for reference in an apparatus on a network from another apparatus on the network, and is improved in the usage efficiency of a storage resource. In the file system, a file stored in a first apparatus for reference is referred to from a second apparatus via a network. Based on a user operation, a linking method for referring to the file from the second apparatus is set to one of soft linking for directly accessing and referring to the file and hard linking for referring to a duplicate of the file stored in the second apparatus. The one of soft linking and hard lining is changed to the other according to frequency of reference from the second apparatus to the file.

### BACKGROUND OF THE INVENTION

1. Field of the Invention

The present invention relates to a file system in which a file stored in a first apparatus for reference is referred to from a second apparatus, a data processing apparatus, a file reference method, and a storage medium storing a program for implementing the file reference method.

2. Description of the Related Art

Recently, network techniques have been markedly developed, and a large number of data processing apparatuses are connected to a network. These apparatuses on the network are each store various kinds of data. For example, an HTTP server stores data written in HTML language. In this case, another apparatus, e.g. a personal computer (hereinafter referred to as “PC”) accesses the HTTP server via the network, and refers to data stored in the HTTP server using a WWW browser.

Some network resources are each provided by a “link” defining a resource reference. The “link” is used for a PC to reach a device (e.g. server) that stores data, based on location information associated with the data, and finally access to an entity of the data (the data itself). The term “location information” is intended to mean, e.g. in the case of the network, a combination of address information on the server on the network, which is required to access the server, and storage location information on the data within the server.

The above-mentioned link makes it possible to reduce the amount of storage of data in the PC, and at the same time, when data as a single entity exists, makes it possible to appear as if there were a plurality of entities of the same data.

Further, there have been conventionally used a digital multifunction apparatus that has a file server function. The digital multifunction apparatus reads images on originals, and stores data of the originals in a memory thereof. Then, the apparatus reads out a desired one of the data of the images accumulated in the memory, on an as needed basis, and prints out the image.

For the memory in which the read image data are accumulated, a hard disk drive (HDD) is often used, but since the storage capacity of the HDD is not limitless, the amount of information that can be accumulated within the apparatus is also limited. To eliminate this inconvenience, for a system having a plurality of digital multifunction apparatuses connected via a network, there has been proposed a method for causing one digital multifunction apparatus to appear to have a large number of document files. This method is called a network-distributed storage management method, and this method uses a linking method in which document files accumulated in each digital multifunction apparatus are made referable from the digital multifunction apparatuses.

The linking method includes two types, a linking method called hard linking and a linking method called soft linking. For example, let it be assumed that among a plurality of digital multifunction apparatuses connected via the network, a digital multifunction apparatus that accumulates respective entities of data items (original documents) is used as an access destination apparatus, and a digital multifunction apparatus that refers to data items accumulated in the access destination apparatus is called an access source apparatus.

In the above system, when the hard linking is used as the linking method, the access source apparatus stores respective copies of entities of the data items accumulated in the access destination apparatus. Then, when referring to any of the data items, the access source apparatus refers to a corresponding one of the copies thereof. In contrast, when the soft linking is used as the linking method, the access source apparatus stores address information on the access destination device, and storage location information on the data items to be accessed but not the respective copies of the entities of the data items. Therefore, when the access source apparatus refers to a desired one of the entities of the data, the access source apparatus accesses the desired one of the entities of the data items in the access destination apparatus based on the address information and the storage location information the data item.

As described above, in the case of the hard linking, data items as copies of originals exist in the access source apparatus, and hence each data item can be accessed at high speed. On the other hand, the access source apparatus requires a storage source, such as HDDS, for storing the copies of the data items. In the case of the soft linking, the access source apparatus does not store the data items themselves, and hence does not necessitate a large capacity of storage source. However, the access source apparatus refers to each data item via the network, and hence it sometimes take long time to refer to the data item depending on the load condition of the network.

Therefore, it is efficient to use hard linking for data which is frequently accessed from the access source apparatus, and soft linking for data which is accessed at a lower frequency.

However, the frequency of access to data dynamically changes, and it is difficult to determine a suitable linking method for the data in view of the access frequency. As a result, it is very difficult to increase the efficiency of usage of memory resources within the access source apparatus.

Further, as the method of improving the efficiency of access to data, there has been proposed a cash method in memory access. The cash method is employed in a system which is provided with a memory A which is large in capacity but low in access speed, and a fixed-size memory B (cash memory) which is small in capacity but high in access speed. The memory A stores all the data, and out of all data, data which are accessed frequently are stored also in the memory B.

For this cash method, there has been proposed a method of effectively using the fixed-size cash memory (see Japanese Patent Laid-Open Publication No. H06-124239). This method calculates the frequencies of access to data items during a predetermined time period, and data items accessed at higher frequencies are made resident in the cash memory and data items accessed at lower frequencies are released from the state of being resident in the cash memory.

However, the method of making effective use of the fixed-size cash memory is suited to a stand-alone information processing apparatus, such as a personal computer, but not to a network-distributed storage management system comprised of a plurality of image processing apparatuses, such as digital multifunction apparatuses, because the plurality of image processing apparatuses are demanded to make optimally efficient use of their own memories (HDDs), respectively, independently of each other.

### SUMMARY OF THE INVENTION

The present invention provides a file system which is reduced in time taken to refer to a file stored for reference in an apparatus on a network from another apparatus on the network, and is improved in the efficiency of usage of a storage resource.

Further, the present provides a data processing apparatus and a file reference method which provide the above-mentioned advantageous effects, and a storage medium storing a program for implementing the file reference method.

In a first aspect of the present invention, there is provided a file system including a first apparatus that stores a file for reference, and a second apparatus that is connected to the first apparatus via a network, in which the file can be referred to from the second apparatus, comprising a linking method-setting unit configured to set, based on a user operation, a linking method for referring to the file stored in the first apparatus from the second apparatus, to one of a first linking method in which the file is directly accessed and referred to and a second linking method in which a duplicate of the file stored in the second apparatus is referred to, and a linking method-changing unit configured to change the one of the first and second linking methods set as the linking method to the other of the first and second linking methods, according to frequency of reference from the second apparatus to the file.

In a second aspect of the present invention, there is provided a data processing apparatus, comprising a setting unit configured to set a linking method by which a file stored in another apparatus is referred to from the data processing apparatus to one of a first linking method in which the file is referred to by directly accessing the file, and a second linking method in which a duplicate of the file stored in the data processing apparatus is referred to, and a change unit configured to change the one of the first and second linking methods set as the linking method to the other of the first and second linking methods, according to frequency of reference from the second apparatus to the file.

In a third aspect of the present invention, there is provided a file reference method of referring to a file stored in a first apparatus for reference from a second apparatus connected to the first apparatus via a network, comprising a linking method-setting step of setting, based on a user operation, a linking method by which the file stored in the first apparatus is referred to from the second apparatus, to one of a first linking method in which the file is directly accessed and referred to and a second linking method in which a duplicate of the file stored in the second apparatus is referred to, and a linking method-changing step of changing the one of the first and second linking methods set as the linking method to the other of the first and second linking methods, according to frequency of reference from the second apparatus to the file.

In a fourth aspect of the present invention, there is provided a storage medium storing a program for causing a computer to execute a file reference method of referring to a file stored in a first apparatus from a second apparatus connected to the first apparatus via a network, in a computer-readable manner, wherein the file reference method comprises a linking method-setting step of setting, based on a user operation, a linking method by which the file stored in the first apparatus is referred to from the second apparatus, to one of a first linking method in which the file is directly accessed and referred to and a second linking method in which a duplicate of the file stored in the second apparatus is referred to, and a linking method-changing step of changing the one of the first and second linking methods set as the linking method to the other of the first and second linking methods, according to frequency of reference from the second apparatus to the file.

According to the present invention, it is possible to reduce time taken to refer to a file stored for reference in an apparatus on a network from another apparatus on the network, and improve the efficiency of usage of a storage resource.

The features and advantages of the invention will become more apparent from the following detailed description taken in conjunction with the accompanying drawings.

### BRIEF DESCRIPTION OF THE DRAWINGS

FIG. 1 is a block diagram of a file system according to a first embodiment of the present invention.

FIG. 2 is a view of an example of the construction of an operating section of a digital multifunction apparatus 10 appearing in FIG. 1.

FIG. 3 is a view of a user interface screen of the digital multifunction apparatus 10 which stores shared documents.

FIGS. 4A to 4C are respective views of user interface screens of a digital multifunction apparatus 20.

FIG. 5 is a view of a data structure of a box “02” in the digital multifunction apparatus 10.

FIG. 6 is a view of a data structure of a box “00” in the digital multifunction apparatus 20.

FIG. 7 is a view of an example of a construction of link information stored in the box “00” in the digital multifunction apparatus 20.

FIGS. 8A and 8B are respective views of user interface screens of a digital multifunction apparatus 30.

FIG. 9 is a view of a data structure of a box “00” in the digital multifunction apparatus 30.

FIG. 10 is a view showing types of icons each displayed in association with a document stored in a box.

FIG. 11 is a view of an example of a configuration of an access management table 110 stored in the digital multifunction apparatus appearing in FIG. 1.

FIG. 12 is a flowchart of a process in which the digital MFP 10 appearing in FIG. 1 registers shared documents based on a link request from the digital multifunction apparatuses 20 to 40.

FIG. 13 is a flowchart of a process in which any of the digital multifunction apparatuses 20 to 40 in FIG. 1 refers to a shared document, using a soft link or a hard link.

FIG. 14 is a flowchart of a process in which the digital multifunction apparatus 10 in FIG. 1 updates an access count in the access management table.

FIG. 15A is a flowchart of a process for updating linking methods recorded in the access management table by the digital multifunction apparatus 10.

FIG. 15B is a continuation of the flowchart of FIG. 15A.

FIG. 16 is a flowchart of a process for changing a linking method based on a link change instruction signal from the digital multifunction apparatuses 20 to 40 in FIG. 1.

FIG. 17 is a view of an example of an update of the access management table in FIG. 11.

FIG. 18 is a block diagram of a file system according to a second embodiment of the present invention.

FIG. 19 is a flowchart of a process executed by a file sharing server when a client PC appearing in FIG. 18 accesses a file sharing server so as to refer to a file in a shared holder.

FIG. 20 is a flowchart of a process executed by each of the client PCs for referring to a file.

### DETAILED DESCRIPTION OF THE EMBODIMENTS

The present invention will now be described in detail with reference to the drawings showing preferred embodiments thereof.

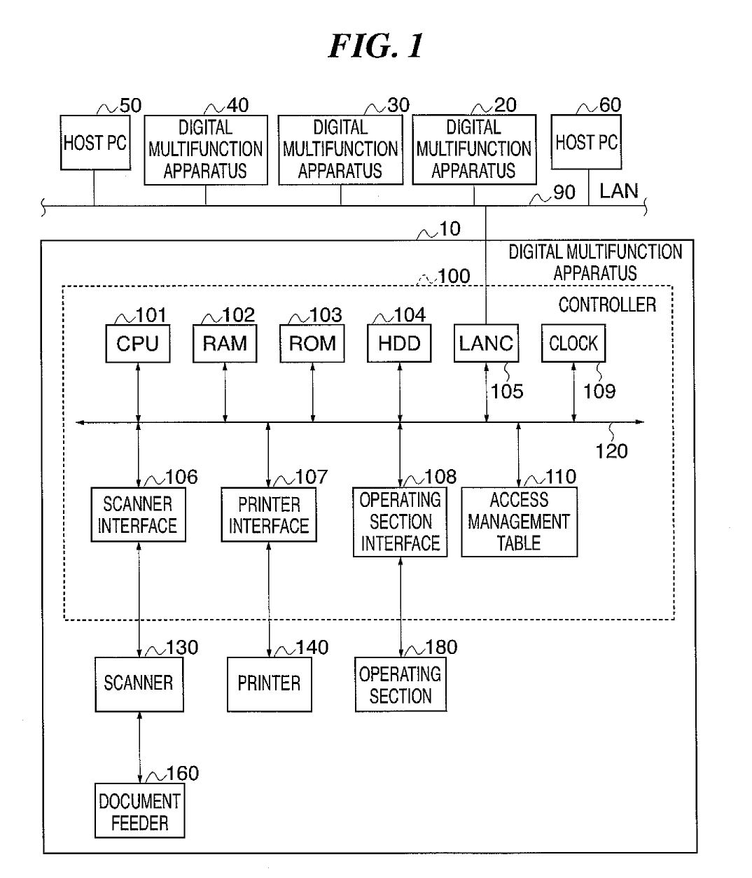

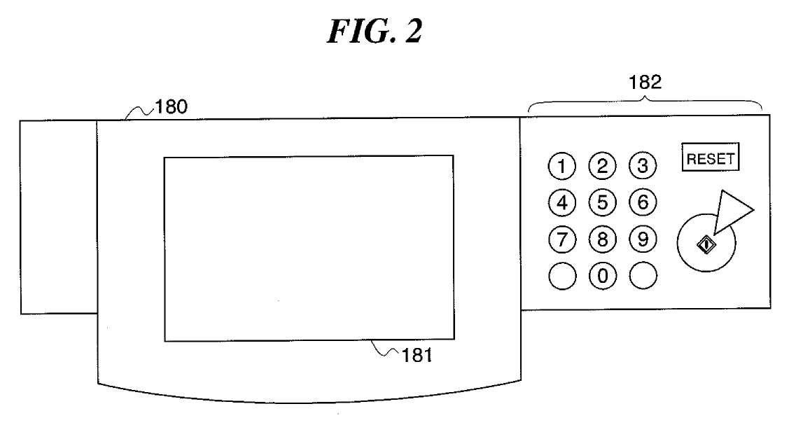

FIG. 1 is a block diagram of a file system according to a first embodiment of the present invention. FIG. 2 is a view of an example of a construction of an operating section of a digital multifunction apparatus 10 appearing in FIG. 1.

The file system according to the present embodiment is, as shown in FIG. 1, capable of sharing at least one file between a plurality of digital multifunction apparatuses (hereinafter referred to as the “digital MFPs”) 10, 20, 30, and 40. Each of the digital MFPs 10, 20, 30, and 40 is connected to a network, e.g. a LAN (Local Area Network) 90. Further, the LAN 90 has a plurality of host PCs (Personal Computers) 50 and 60 connected thereto.

The digital MFPs 10 to 40 each have a function of inputting and outputting an image. For example, they each read an image on an original, and have data of the read image input thereto. Further, they are each capable of having image data sent from another apparatus on the LAN 90 input thereto. Moreover, they each store the input image data, and print the image data on sheets. Also, they are each capable of transferring the image data to another apparatus via the LAN 90.

Now, a description will be given of the configuration of the digital MFP 10. The digital MFP 10 includes a controller 100. The controller 100 is connected to a scanner 130 and a printer 140, for controlling the operations of the scanner 130 and the printer 140. Further, the controller 100 is connected to the LAN 90, and controls the input and output of image data, device information, etc. via the LAN 90.

The controller 100 includes a CPU 101, a RAM 102, a ROM 103, an HDD (hard disk drive) 104, and a LAN controller (LANC) 105. Further, the controller 100 includes a scanner interface 106, a printer interface 107, an operating section interface 108, a clock 109, and an access management table 110. These blocks are connected to a system bus 120.

The CPU 101 controls the input and output of image data, device information, etc. according to a program stored in the ROM 103 or the HDD 104, and controls the operations of the blocks connected to the system bus 120. The RAM 102 provides a work area for the CPU 101. The HDD 104 stores programs, image data, and so forth.

The LAN controller 105 is connected to the LAN 90, and sends and receives image data, device information, etc. to and from the apparatuses on the LAN 90.

The scanner interface 106 connects between the CPU 101 and the scanner 130, and controls the sending and receiving of data therebetween. Here, the scanner 130 has a document feeder 160 installed thereon for sequentially feeding a plurality of sheets of an original one by one to the scanner 130. The scanner scans each sheet of the original fed from the document feeder 160.

The printer interface 107 connects between the CPU 101 and the printer 140, and controls the sending and receiving of data between the CPU 101 and the printer 140. The printer 140 performs printing based on image data input thereto. The printer 140 is implemented by a laser beam printer, an ink jet printer, or a like printer.

The operating section interface 108 controls the sending and receiving of data between the CPU 101 and an operating section 180. The operating section 180 is comprised, e.g. as shown in FIG. 2, of a key group 182 including a plurality of hard keys for enabling the user to input various kinds of configuration information, and a liquid crystal display panel 181 for displaying images of settings, a status of the apparatus, etc. Further, the liquid crystal display panel 181 is capable of displaying soft keys for performing various kinds of configuration.

Information input from the operating section 180 by the user is sent to the CPU 101 via the operating section interface 108. The CPU 101 performs associated processing based on the information input thereto. Further, the operating section 180 displays information input thereto from the CPU 101 via the operating section interface 108 on the liquid crystal panel 181.

The clock 109 provides date and time information. The clock 109 is backed-up by a battery, not shown, such that it is operable even during power-off of the apparatus.

The access management table 110 is used in recording the number of times (count) of access to data stored in a box provided in the HDD 104 by each device connected to the LAN 90. The access management table 110 is illustrated as separate from the HDD 104, but actually, it is stored within the HDD 104. Details of the access management table 110 will be described hereinafter.

In the present embodiment, the other digital MFPs 20 to 40 are assumed to have the same configuration as the digital MFP 10, and description of the configuration of each of them is omitted.

In the present embodiment, files to be referred to (hereinafter referred to as “shared documents”) stored in the digital MFP 10 (first apparatus) can be referred to using a linking method set by the user from each of the digital MFPs 20 to 40 (second apparatus). Here, the linking method set by the user includes soft linking for setting a soft link and hard linking for setting a hard link. The soft linking is a linking method which enables each of the digital MFPs 20 to 40 to directly access a desired one of the shared documents stored in the digital MFP 10 via the LAN 90 to thereby refer to the desired shared document, while the hard linking is a linking method which enables each of the digital MFPs 20 to 40 to store respective copies of shared documents stored in the digital MFP 10, and refer to a desired one of the copies of the shared documents stored therein.

The shared documents stored within the digital MFP 10 are each referred to by each of the digital MFPs 20 to 40 using a soft link or a hard link. Therefore, in order to determine whether the linking method set by the user is an appropriate one, the digital MFP 10 is required to keep track of which linking method is used by each of the digital MFPs 20 to 40 so as to refer to each of the shared documents. For the management purposes, the digital MFP 10 stores the access management table 110. Details of the access management table 110 will be described hereinafter.

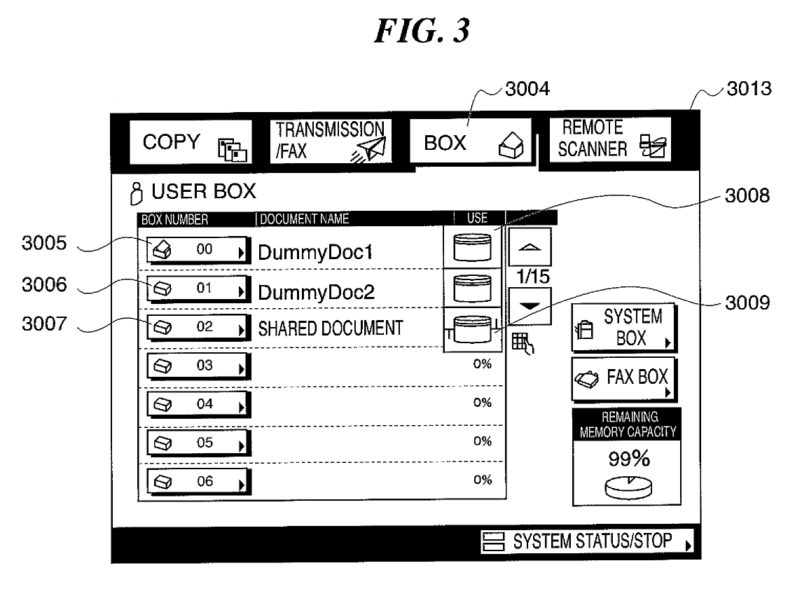

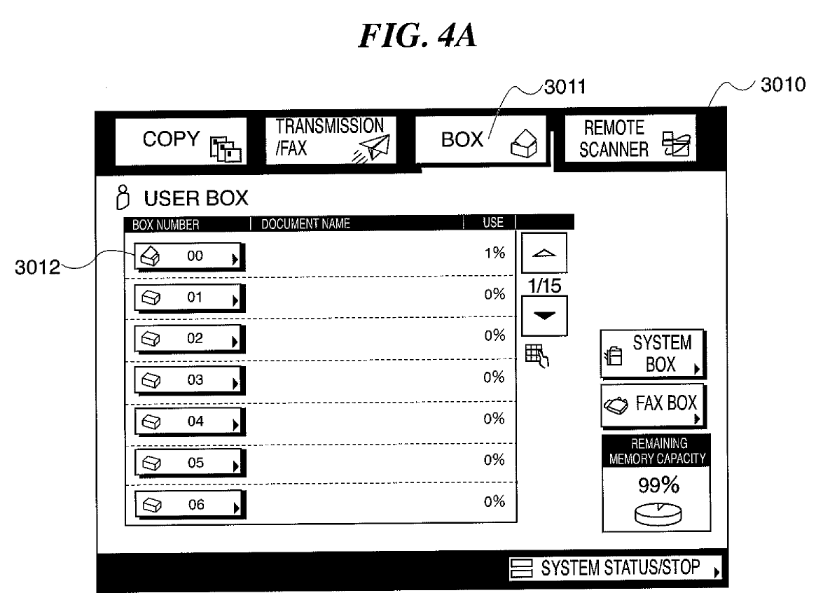

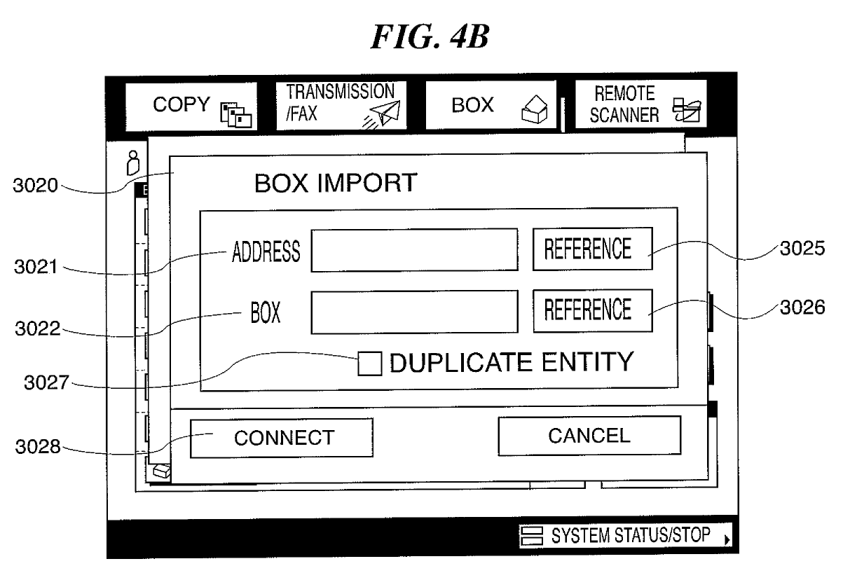

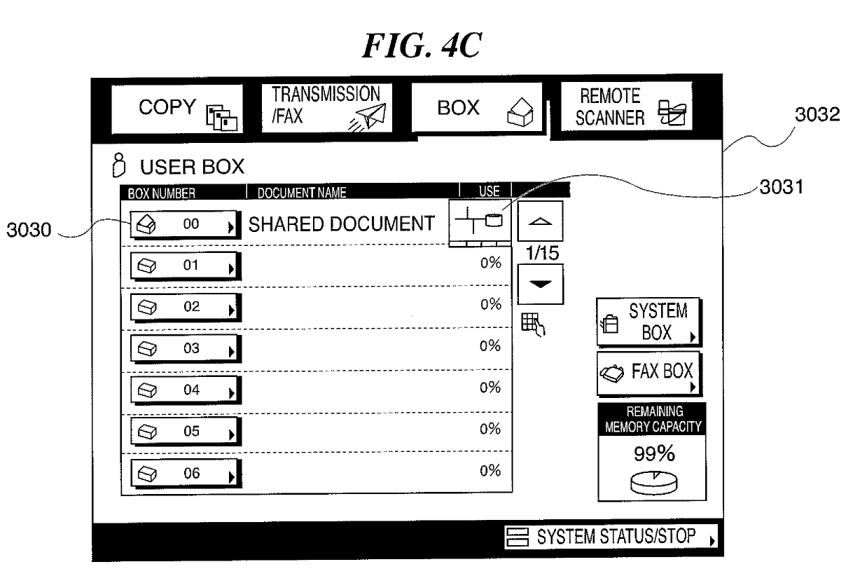

Next, the setting of the linking method by which shared documents stored in the digital MFP 10 are referred to by the digital MFPs 20 to 40 will be described with reference to FIG. 3 and FIGS. 4A to 4C. FIG. 3 is a view of a user interface screen of the digital MFP 10 which stores shared documents. FIGS. 4A to 4C are views of user interface screens of the digital MFP 20.

The digital MFP 10 displays the user interface screen 3013 on the liquid crystal panel 181 of the operating section 180 e.g. as shown in FIG. 3, for enabling the user to select a desired one of a plurality of functions provided therefor. To select a box function, a box tab 3004 is selected on the user interface screen 3013. This causes a box selection screen to be displayed on the liquid crystal panel 181. On the box selection screen, there are displayed a button 3005 associated with a box “00” a button 3006 associated with a box “01”, a button 3007 associated with a box “02”, and other buttons associated with boxes having respective numbers. Each box is provided in a predetermined area within the HDD 104.

Further, a name of a document stored in the box, and an icon indicative of a location where the document is stored are displayed in association with each button. Here, in the case of an icon for a document which is not referred to from the digital MFPs 20 to 40, i.e. which is not a shared document, the icon therefor indicates that the document can be referred only from the digital MFP 10 alone. In contrast, in a case where a document stored in a box of the digital MFP 10 is a shared document, the icon therefor indicates that the document can be accessed from the digital MFPs 20 to 40 via the LAN 90.

In the box selection screen, in association with the box “00” in the digital MFP 10, there are shown a document name “DummyDoc1” of a document stored therein, and an icon 3008 indicating that the document is stored in the HDD 104 of the digital MFP 10 and cannot be accessed from any of the digital MFPs 20 to 40.

In association with the box “02”, there are shown a document name “shared document” of a document stored therein, and an icon 3009 indicating that the document is stored in the HDD 104 of the digital MFP 10 and can be accessed from the digital MFPs 20 to 40.

On the box selection screen, when a button corresponding to a desired box is pressed, the box is selected, which makes it possible to read out a document stored therein. Further, it is possible to store a desired document in a selected box.

In the digital MFP 20, similarly to the digital MFP 10, a user interface screen 3010 as shown in FIG. 4A is displayed on the liquid crystal panel 181 of the operating section 180. On the user interface screen 3010, a box tab 3011 is selected. Then, a box selection screen is displayed on the liquid crystal panel 181. The construction of the box selection screen is the same as that of the above-described box selection screen of the digital MFP 10.

Now, let it be assumed that soft linking is set as a linking method by which the shared document stored in the box having the number “02” in the digital MFP 10 is referred to from the digital MFP 20. In this case, a box “00” in the digital MFP 20 is designated as a box of the digital MFP 20 which is caused to appear to store the shared document.

To do this, first, on the box selection screen of the digital MFP 20, a button 3012 associated with a box “00” is pressed. The box “00” is currently in a vacant state storing no document.

Then, when the button 3012 is pressed, a “box import button” (not shown) is displayed, and by depressing the box import button, a box import screen 3020 as shown in FIG. 4B is displayed.

The box import screen 3020 is provided with an address information entry box 3021 for entering information on the address of a node from a box is to be imported, and a box information entry box 3022 for entering the number of the box. In the illustrated example, it is assumed “NodeA” is entered as the address information on the digital MFP 10 in the address information entry box 3021, and “02” is entered as the box number of the digital MFP 10 in the address information entry box 3022.

Further, the aforementioned box import screen 3020 is provided with reference buttons 3025 and 3026 for use in referring to the address information to be entered in the address information entry box 3021 and the box number to be entered in the box number entry box 3022.

Furthermore, the box import screen 3020 is provided with a check box 3027 for selecting whether to duplicate the entity (document itself) of a shared document. In the illustrated example, it is assumed that the check box 3027 is not checked to set soft linking as the linking method. In contrast, to set hard linking as the linking method, the check box 3027 is checked.

Thus, after performing an operation for setting soft linking as the linking method by which the shared document in the digital MFP 10 is referred to, a connection button 3028 is pressed. This causes the digital MFP 20 to make a link request to the digital MFP 10. The link request contains the apparatus name of the digital MFP 20, the document name of the shared document, and the linking method (soft linking in the illustrated example).

The digital MFP 10 having received the link request sends information corresponding to the linking method to the digital MFP 20. Since it is assumed here that soft linking has been selected, management information, referred to hereinafter, on the shared document is sent to the digital MFP 20. The digital MFP 20 displays a screen 3032 as shown in FIG. 4C on the operating section 180 based on the management information from the digital MFP 10.

On this screen 3032, the name of the shared document is displayed in association with a button associated with a box “00”. That is, this indicates that the box “00” stores the shared document, and if a button 3030 is pressed, the shared document can be read out from the box “00”.

Here, in the case of soft linking, the box “00” of the digital MFP 20 does not store the entity of the shared document, but stores the address information on the digital MFP 10 storing the entity of the shared document and the box number “02” as link information. This causes the box “00” of the digital MFP 20 to appear to store the shared document. To indicate this fact, in association with the button 3030, an icon 3031 is displayed indicating that the shared document is stored in the HDD 104 of the digital MFP 10, and the digital MFP 20 can access the HDD 104.

The aforementioned soft linking is the method by which a document in an access destination apparatus (digital MFP 10) is accessed from an access source apparatus (digital MFP 20) via the LAN 90. Therefore, soft linking has an advantage of reducing the capacity of a storage (local storage), such as a HDD, in the access source apparatus. In other words, the digital MFP 20 is capable of registering a large number of documents without depending on the capacity of the local storage. Further, an access source apparatus having no local storage becomes capable of sharing documents. However, soft linking causes a document in the access destination apparatus to be referred to from the access source apparatus via the LAN 90, and hence there is a fear that the productivity is lowered due to long time taken to transfer the document.

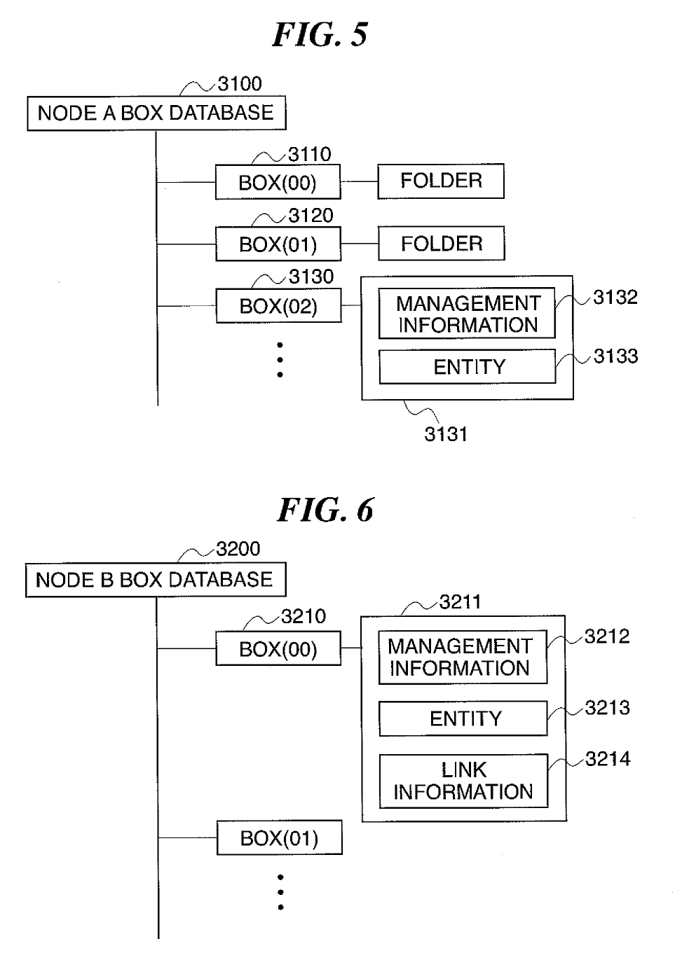

Next, a description will be given of the data structure of the box “02” of the digital MFP 10 with reference to FIG. 5. FIG. 5 is a view of the data structure of the box “02” of the digital MFP 10.

In the digital MFP 10, as shown in FIG. 5, boxes 3110, 3120, 3130, . . . , are provided within the HDD 104 as boxes under a node A box database 3100 having a hierarchical structure. Now, the box 3130 is the aforementioned box “02” that stored the shared document. The box 3130 has a folder 3131. The folder 3131 stores management information 3132 including a plurality of items of information for managing the shared document (e.g. link node information, a name, a password, an effective period, etc.) and an entity 3133 of the shared document.

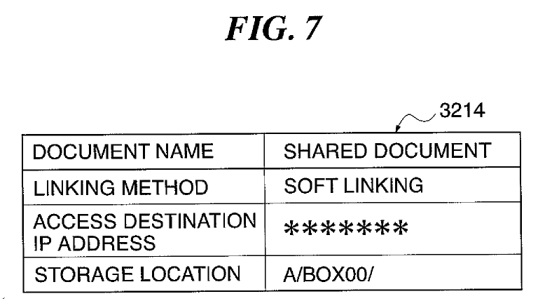

Next, a description will be given of the data structure of the box “00” of the digital MFP 20 in which the shared document appears to be stored by soft linking, with reference to FIGS. 6 and 7. FIG. 6 is a view of the data structure of the box “00” of the digital MFP 20, and FIG. 7 is a view of an example of a construction of link information stored in the box “00” of the digital MFP 20.

In the digital MFP 20, as shown in FIG. 6, a box 3210 (box “00”) is provided in the HDD 104 as one of boxes under a node B box database 3200 having a hierarchical structure. The box 3210 has a folder 3211. The folder 3211 stores management information 3212 including a plurality of items of information for managing the shared document (e.g. link node information, a name, a password, an effective period, etc.) and an entity 3213 of the shared document, and link information 3214.

Here, the entity 3213 in the folder 3211 is not the document itself but the management information 3132 in the box 3130 of the digital MFP 10. The link information 3214 includes, e.g. as shown in FIG. 7, a document name, location information (e.g. address information on the digital MFP 10 and the box number of the digital MFP 10), and a linking method (e.g. soft linking).

To refer to the shared document from the digital MFP 20, first, the management information 3212 is referred to, and then, the entity 3213 and the link information 3214 are read out. This makes it possible to refer to the management information including the name of the shared document. Further, based on the link information 3214, the shared document in the digital MFP 10 is accessed, which makes it possible to refer to the shared document on the digital MFP 20.

The easiest method to refer to the management information concerning the shared document is an NFS mount. The NFS mount is a function of making a specific directory of a file system in a specific access destination appear to be a local storage. By using this, it is possible to connect to a storage at another node. That is, the digital MFP 20 can access documents other than the shared document without being restricted by the management information 3212. Therefore, the digital MFP 20 is capable of executing an operation performed on the shared document in the box “02” at the node A of the digital MFP 10, apparently as if the operation was performed on a document in the box “00” at the node B thereof.

Thus, information which is desired to be let known by an immediate response, e.g. a document name, is recorded as information in the aforementioned entity 3213 (i.e. the management information 3132). In contrast, the entity of each document is a dominant factor affecting the remaining capacity of the box, and hence the link information 3214 is recorded so as to be referred to from the access source. That is, for an access source apparatus which does not have a large-capacity storage, it is desired to use an NFS method. On the other hand, for an access source apparatus which has a large-capacity storage, it is desired to link only the entity of a document.

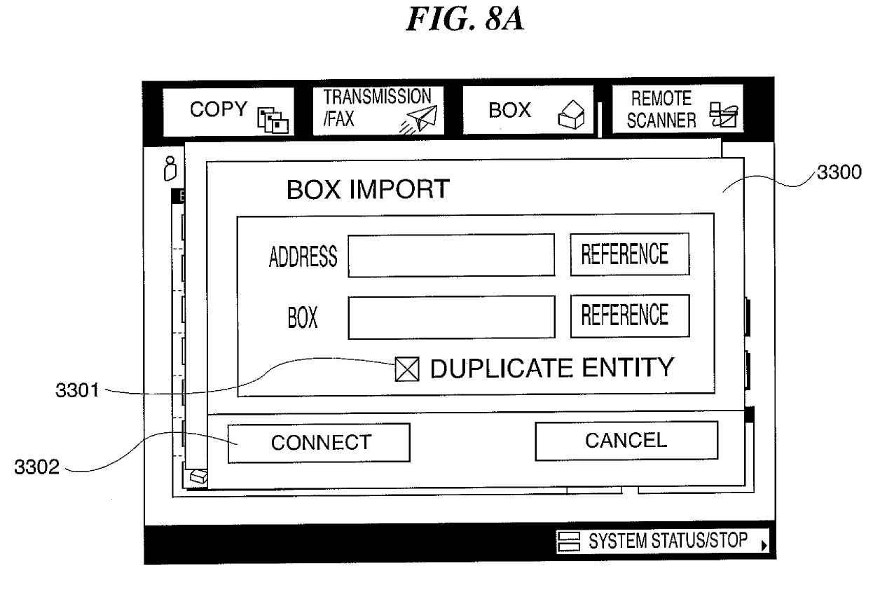

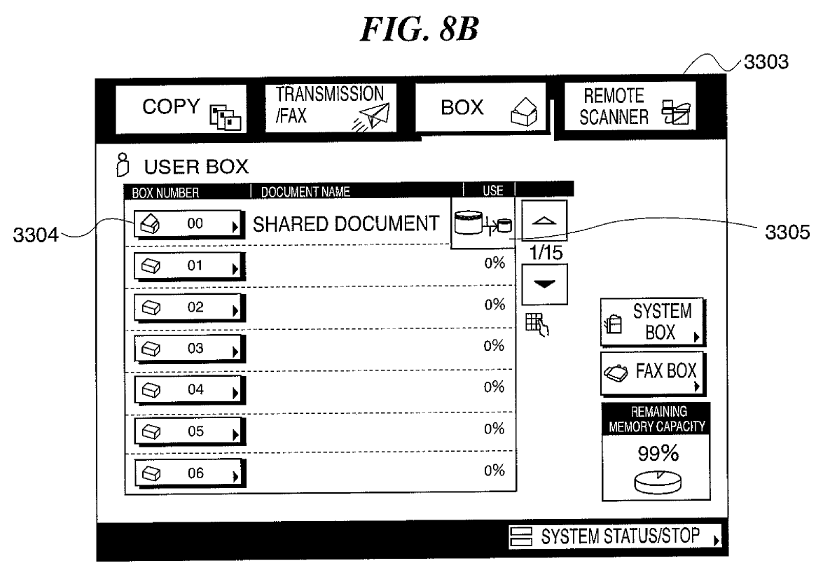

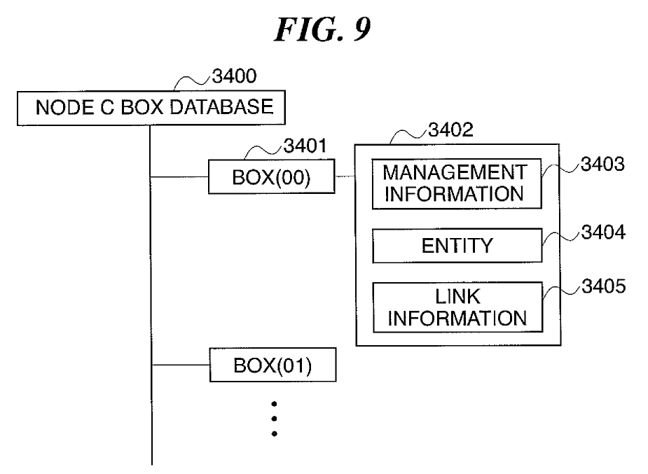

Next, hard linking will be described with reference to FIGS. 8A and 8B and FIG. 9. FIGS. 8A and 8B are views showing user interface screens of the digital MFP 30. FIG. 9 is a view of the data structure of a box “00” of the digital MFP 30.

When the digital MFP 30 refers to the shared document stored in the box “02” of the digital MFP 10 using a hard link, setting of hard linking is performed by the digital MFP 30. In this case, the same operation as performed by the digital MFP 20 when setting soft linking is performed by the digital MFP 20. After displaying a box import screen 3300 as shown in FIG. 8A by this operation causes, address information on a node from a box is to be imported and a box number are entered. Then, to set hard linking, a checkbox 3301 for selecting whether to duplicate the entity of a file (document itself) when a link request is made is marked.

Thus, after the digital MFP 30 sets hard linking as the linking method by which the shared document stored in the box “02” of the digital MFP 10 is referred to, a connection button 3302 is pressed, which causes a link request to be sent from the digital MFP 30 to the digital MFP 10. Then, based on information sent back from the digital MFP 10 in response to the link request, the management information of the shared document and the duplicate of the entity of the shared document are stored in the box “00”.

Next, based on the management information, a screen 3303 as shown in FIG. 8B is displayed on the operating section 180 of the digital MFP 30. On the screen 3303, the name of the shared document is displayed in association with a button 3304 associated with the box “00”. Here, since the aforementioned checkbox 3301 is marked, the duplicate of the entity of the shared document is stored in the box “00”. Then, when the button 3304 is pressed, it is possible to read out the shared document (duplicate) from the box “00”. Further, in association with the button 3304, an icon 3305 indicating that the shared document in the digital MFP 30 is referred to by hard linking is displayed.

In the digital MFP 30, as shown in FIG. 9, a box 3401 (the box “00”) is provided in the HDD 104 as one of boxes under a node C box database 3400 having a hierarchical structure. The box 3401 has a folder 3402. The folder 3402 stores management information 3403 for managing the shared document, an entity 3404 of the shared document, and link information 3405. Here, the management information 3403 is a duplicate of the management information 3132 in the box 3130 of the digital MFP 10. Further, similarly, the entity 3404 is the duplicate of the entity 3132 of the box 3130.

In the case of hard linking, the document (duplicate) stored in the box “00” is required to be handled as dependent data of an original. Normally, in the case of a duplicate (copy) which does not inherit the update information of an original thereof, when the original is updated, the duplicate thereof remains on the network in a state before update, which makes it very difficult to make the version of the original and that of the duplicate match each other. Therefore, in the case of a hard link, to improve accessibility to data, the duplicate of the original is stored, but it is necessary to explicitly indicate that the duplicate is dependent data of the original. To this end, the link information 3405 is recorded.

Thus, the hard linking is a method of storing an entity of a duplicate of a document, and managing link information on the original of the document.

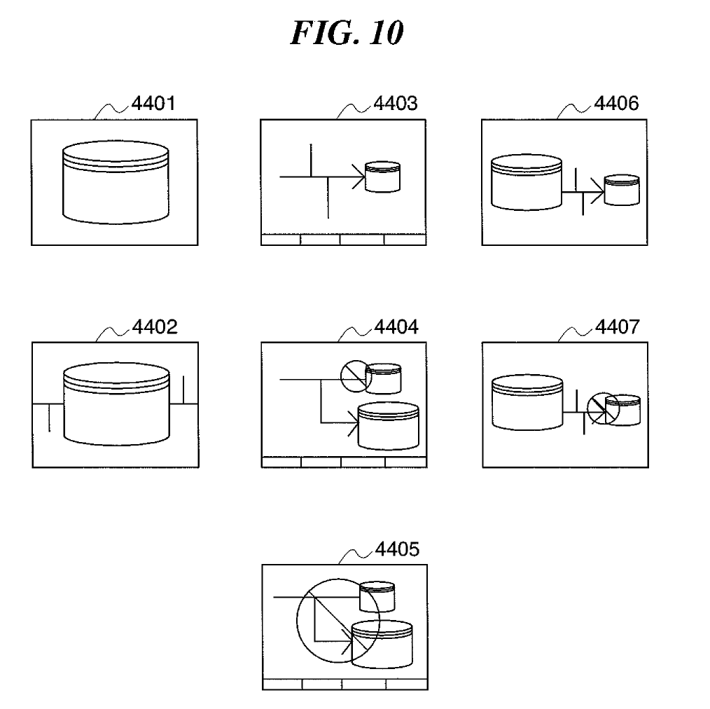

Next, a description will be given of icons displayed in association with documents stored in respective boxes with reference to FIG. 10. FIG. 10 is a view showing types of icons displayed in association with respective documents stored in boxes.

In the present embodiment, in managing documents in boxes of the digital MFPs 10 to 40, it is important to explicitly indicate whether a document in a box is an original or one shown by a soft link or a hard link.

In the network-distributed storage system, as found in a peer-to-peer form, when duplication is repeated without control, there arise inconveniences that it is impossible to delete the data, and that accessibility to newest data is not guaranteed, for example. From the viewpoint of document management, this means the fact that documents cannot be properly managed, i.e. “failure” of document management.

Therefore, in the present embodiment, to improve reliability and security of data, icons are displayed in association with respective boxes as a means for explicitly indicating in what form a document exists in each box.

As shown in FIG. 10, there are various types of icons 4401 to 4408 which are displayed in association with documents in boxes. An icon 4401 indicates that a document associated therewith is an original, and cannot be referred to from other apparatuses on the LAN 90. In the illustrated example, assuming that the document in the box is deleted, the document is completely deleted from the LAN 90. For example, the icon 3008 appearing in FIG. 3 corresponds to the icon 4401.

An icon 4402 represents a soft link. The icon 4402 indicates that a document associated therewith is an original, and the document can be referred to from other apparatuses on the LAN 90. Assuming that the document is deleted, the document cannot be referred to from the other apparatuses. For example, the icon 3009 appearing in FIG. 3 corresponds to the icon 4402.

An icon 4403 represents a soft link. The icon 4403 indicates that a document associated therewith is not an entity, but that when referring to the document, an apparatus storing the entity of the document is accessed based on link information. For example, the icon 3031 appearing in FIG. 4C corresponds to the icon 4403.

An icon 4404 represents a soft link. The icon 4404 indicates that a document associated therewith is not an entity, and when referring to the document, it is impossible to access an apparatus storing the entity (original) of the document. Further, the icon 4404 indicates that it is possible to access an apparatus that stores a substitute document for the original. That is, the original cannot be accessed but the substitute document can be accessed in place of the original.

An icon 4405 represents a soft link. The icon 4405 indicates that a document which is stored in a box associated with the icon is not an entity, and when referring to the document, it is impossible to access an apparatus that stores the entity (original) of the document. Further, the icon 4405 indicates that it is also impossible to access the apparatus that stores a substitute document of the original. That is, it is impossible to access the original and the substitute document as a substitute for the original, and it is impossible to execute a job by designating the document in the box with which the icon 4405 is associated.

An icon 4406 represents a hard link. The icon 4406 indicates that the entity of a document which is stored in a box associated with the icon 4406 is a duplicate. For example, the icon 3305 appearing in FIG. 8B corresponds to the icon 4406.

An icon 4407 represents a hard link. The icon 4407 indicates that a duplicate of a document is stored in a box associated with the icon 4407, but it is impossible to access an apparatus that stores the original of the document. When this icon 4407 is displayed, it is possible to execute a job by designating the document in the box, but since it is impossible to access the apparatus storing the original of the document, there is a possibility that the document in the box is not of a latest version.

The above-mentioned various types of icons are shown only by way of example, and are by no means limitative. In other words, each icon is only required to explicitly indicate in which form a document exists in a box, and an icon can be used which is formed using letters, an identification code, a symbol, or the like.

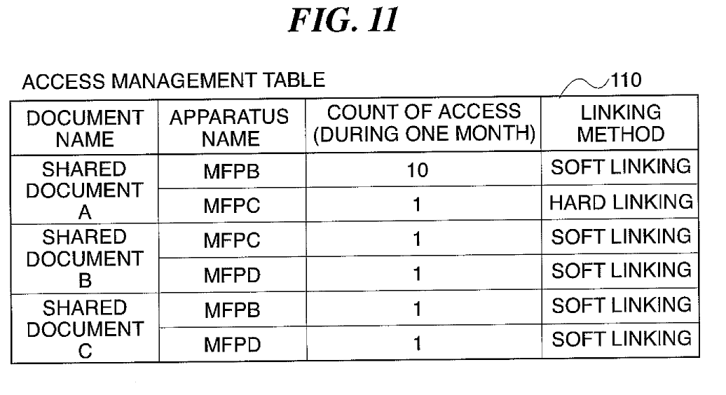

Next, the access management table 110 will be described with reference to FIG. 11. FIG. 11 is a view of an example of a configuration of the access management table 110 stored in the digital MFP 10 appearing in FIG. 1.

The access management table 110 in the digital MFP 10 records numbers of times (counts) of reference to shared documents A, B, and C from the other digital MFPs 20 to 40, and linking methods, as shown in FIG. 11, by way of example. In the illustrated example, the shared documents A, B, and C are stored in boxes different from each other. Further, each recorded access count indicates a total numbers of times of access made during a predetermined time period, such as one month, and is updated whenever each of the other digital MFPs 20 to 40 refers to each of the shared documents A, B, and C. In the illustrated example, each of the shared documents A, B, and C is an original or a duplicate of an original, and is referred to from the digital MFPs 20 to 40 using a soft link or a hard link.

The digital MFP 20 (MFPB) stores link information on the shared document A so as to cause the shared document A to appear to be stored in the box “00” of the digital MFP 20 (see FIGS. 4A to 4C and FIG. 7). Then, when referring to the shared document A, the digital MFP 20 accesses the shared document A in the box “02” provided in the digital MFP 10, based on the link information. That is, the digital MFP 20 uses a soft link to thereby refer to the shared document A in the box “02” in the digital MFP 10.

The digital MFP 30 (MFPC) stores a duplicate (duplicate of the entity) of the shared document A in the box “00” thereof (see FIGS. 8A and 8B and FIG. 9). Then, when referring to the shared document A, the digital MFP 30 directly accesses the duplicate of the shared document A stored in the box “00” of its own. That is, the digital MFP 30 uses a hard link to thereby refer to the duplicate of the shared document A in the box “02” of the digital MFP 10.

Further, the shared document B is referred to from the digital MFP 30 (MFPC) and the digital MFP 40 (MFPD) using respective soft links. The shared document C is referred to from the digital MFP 20 (MFPB) and the digital MFP 40 (MFPD) using respective soft links.

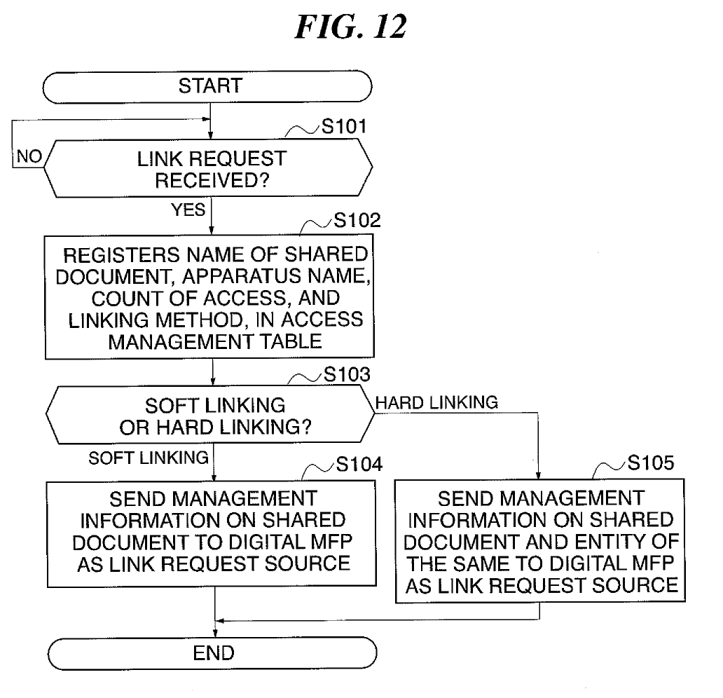

Next, a description will be given of a process in which the digital MFP 10 registers information on a link request source in the access management table in response to a link request from one of the digital MFPs 20 to 40, with reference to FIG. 12. FIG. 12 is a flowchart of the process in which the digital MFP 10 appearing in FIG. 1 registers the shared document based on the link request from the one of the digital MFPs 20 to 40. The process of the FIG. 12 flowchart is executed by the CPU 101 of the digital MFP 10 according to a program stored in the ROM 103.

In the digital MFP 10, as shown in FIG. 12, first, the CPU 102 monitors whether a link request has been received from any of the digital MFPs 20 to 40 on the LAN 90 as a link request source (S101). In the illustrated example, the link request contains the apparatus name of the digital MFP as the link request source, the number of a box where the link request source stores a shared document, and the linking method. When the link request is received, based on the link request, the CPU 101 registers the name of the shared document, the apparatus name, the access count, and the linking method in the access management table 110 in association with each other (step S102). At this time, the access count is set to 0.

Next, the CPU 101 determines whether the linking method contained in the link request is soft linking or hard linking (step S103). At this time, if the linking method is soft linking, the CPU 101 sends the management information on a shared document which the digital MFP as the link request source is to refer to, to the digital MFP as the link request source (step S104), followed by terminating the present process. The digital MFP as the link request source receives the management information on the shared document sent from the digital MFP 10, and stores the same in an associated box.

If it is determined in the step S103 that the linking method is hard linking, the CPU 101 sends the management information on the shared document which the digital MFP as the link request source is to refer to and the entity (duplicate) of the same to the digital MFP as the link request source (step S105). Then, the CPU 101 terminates the present process. The digital MFP as the link request source receives the management information on the shared document and the entity (duplicate) of the same sent from the digital MFP 10, and stores them in an associated box.

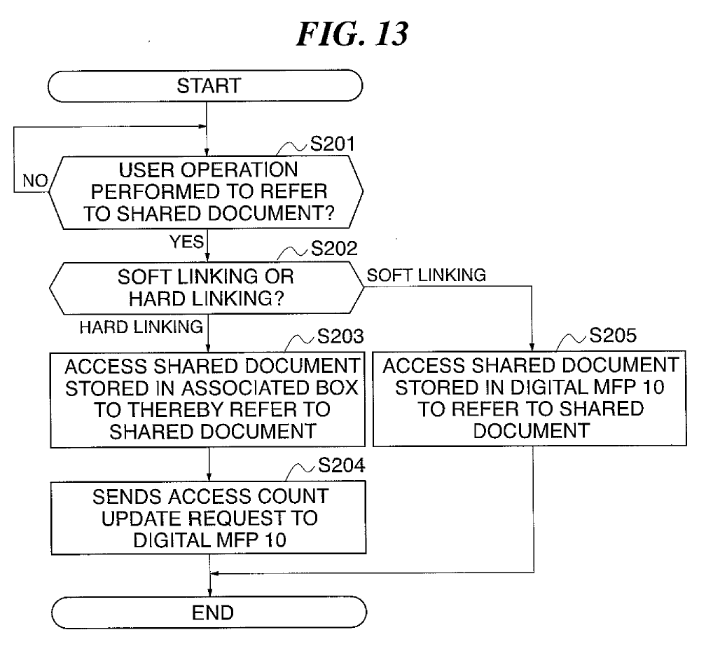

Next, a description will be given of a process in which one of the digital MFPs 20 to 40 refers to a shared document using a soft link or a hard link, with reference to FIG. 13. FIG. 13 is a flowchart of the process in which the one of the digital MFPs 20 to 40 in FIG. 1 refers to the shared document using the soft link or the hard link. The process of the FIG. 13 flowchart is executed by the CPU 101 of each of the digital MFPs 20 to 40 according to a program stored in the ROM 103 thereof.

As shown in FIG. 13, the one of the digital MFPs 20 to 40 (CPU 101 thereof) monitors whether the user has performed an operation for referring to a shared document (step S201). At this time, if the user of the one of the digital MFPs 20 to 40 has performed the operation, the one of the digital MFPs 20 to 40 determines based on the link information stored in the box database of its own, whether the linking method for referring to the shared document is hard linking or soft linking (step S202).

At this time, if the linking method is hard linking, the entity (duplicate) of the shared document is stored in an associated box of the one of the digital MFPs 20 to 40, and hence the one of the digital MFPs 20 to 40 accesses the shared document (duplicate) stored in the associated box to thereby refer to the shared document (step S203). Next, the one of the digital MFPs 20 to 40 sends an access count update request for requesting the update of the number of times (count) of access to the shared document to the digital MFP 10 (step S204), followed by terminating the present process.

On the other hand, if it is determined in the step S202 that the linking method is soft linking, the entity of the shared document is not stored in any box of the one of the digital MFPs 20 to 40. Therefore, the one of the digital MFPs 20 to 40 accesses the shared document stored in an associated box of the digital MFP 10 via the LAN 90, based on the link information on the shared document to refer to the shared document (step S205), followed by terminating the present process.

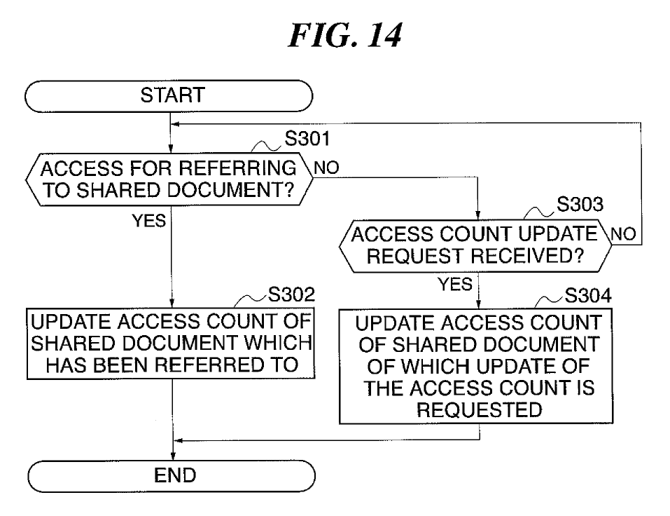

Next, a description will be given of a process in which the digital MFP 10 updates the access count in the access management table, with reference to FIG. 14. FIG. 14 is a flowchart of the process in which the digital MFP 10 in FIG. 1 updates an access count in the access management table. The process of the FIG. 14 flowchart is executed by the CPU 101 of the digital MFP 10 according to a program stored in the ROM 103.

In the digital MFP 10, as shown in FIG. 14, first, the CPU 101 determines whether an access is made for referring to a shared document in the digital MFP 10 using a soft link from any of the digital MFPs 20 to 40 (step S301). When the aforementioned access is made from one of the digital MFPs 20 to 40, the CPU 101 updates the count of access to the shared document from the one of the digital MFPs 20 to 40 (step S302). At this time, the access count is incremented by 1. Then, the CPU 101 terminates the present process.

If it is determined in the step S301 that no access is made from any of the digital MFPs 20 to 40, the CPU 101 determines whether there has been received an access count update request from any of the digital MFPs 20 to 40 (step S303). At this time, if there is no access count update request received from any of the digital MFPs 20 to 40, the CPU 101 returns to the step S301. On the other hand, if there has been received an access count update request from any of the digital MFPs 20 to 40, the CPU 101 updates the access count, in the access management table 110, of the shared document of which the update of the access count is requested by the access count update request (step S304). In the illustrated example, the access count is incremented by 1. Then, the CPU 101 terminates the present process.

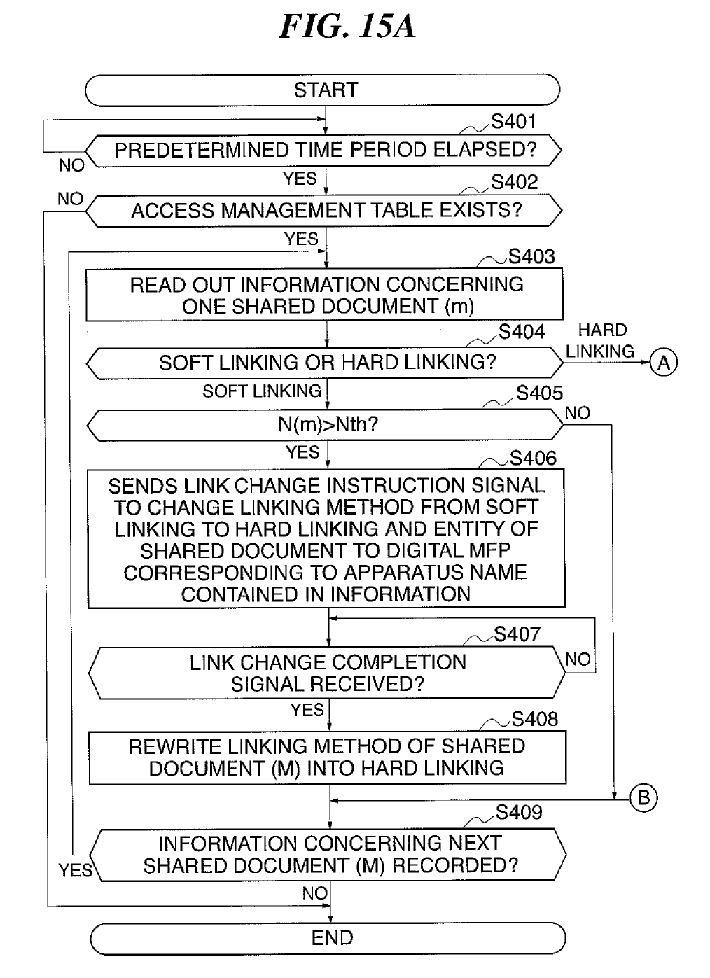

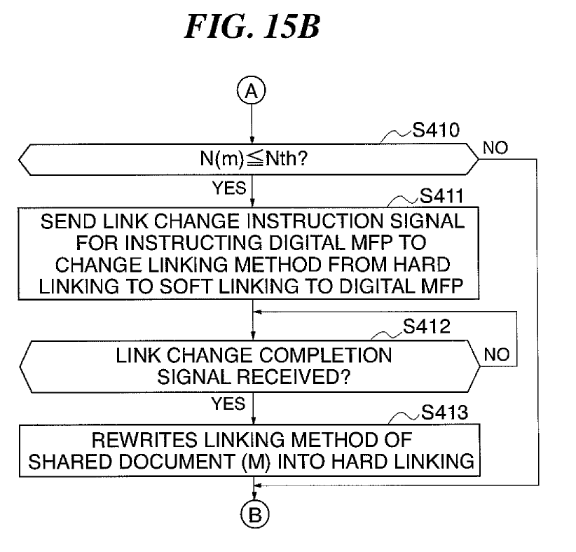

Next, a description will be given of a process for changing linking methods recorded in the access management table 110, with reference to FIGS. 15A and 15B. FIGS. 15A and 15B provide a flowchart of the process in which the digital MFP 10 changes linking methods recorded in the access management table 110. The process of the FIGS. 15A and 15B flowchart is executed by the CPU 101 of the digital MFP 10 according to a program stored in the ROM 103.

In the present embodiment, when a predetermined time period elapses, there is executed the process for changing linking methods recorded in the access management table 110. The access count recorded in the access management table 110 in the illustrated example is updated as occasion arises during one month period (e.g. January 1 through January 31). Then, upon the lapse of the one month period, e.g. when it becomes 0 o'clock a.m. on the first day of each month, the linking method-changing process is executed by referring to he access count in the access management table 110.

Although in the illustrated example, the linking method-changing process is executed at a time point each one month period elapses, it is also possible to configure timing of the changing linking methods to a time point at which a desired time period, such as two months, one week, or one day, elapses, in place of this. In this case, the time period is set by the user. Further, the time period may be set to a predetermined fixed time period.

In the process for changing linking methods of the access management table 110, as shown in FIGS. 15A and 15B, first, the CPU 101 of the digital MFP 10 waits for a predetermined time period (one month in the illustrated example) to elapse (step S401). In the illustrated example, it is judged, for example, that one month has elapsed when the time and date information by the clock 109 indicates that it is 0 o'clock a.m. on the first day of each month. When one month elapses, the CPU 101 determines whether or not the access management table 110 exists in the HDD 104 (step S402). At this time, if the access management table 110 does not exist, the CPU 101 terminates the present process.

If it is determined in the step S402 that the access management table 110 exists, the CPU 101 reads out information concerning one shared document (m) (m≧1) (step S403). Here, the information concerning the shared document (m) contains a document name, an apparatus name of one of the digital MFPs 20 to 40, an access count N(m), and a linking method. Then, the CPU 101 determines, based on the information concerning the shared document (m), whether the linking method of the shared document (m) is soft linking or hard linking (step S404).

If it is determine in the step S404 that the linking method of the shared document (m) is soft linking, the CPU 101 determines whether or not the access count N(m) of the shared document (m) is more than a threshold value Nth (step S405). Here, the case where the access count N(m) is more than the threshold valve Nth is a case in which the shared document (m) is referred to at a high frequency by one of the digital MFPs 20 to 40 corresponding to the apparatus name contained in the information concerning the shared document (m) using a soft link. Therefore, in the case of soft linking, it takes a longer time period for each of the digital MFPs 20 to 40 to refer to the shared document (m), and hence from the view point of reduction of the time period required for reference, it is preferable to change the linking method from soft linking to hard linking. In other words, it is preferable for the apparatus to store the entity (duplicate) of the shared document (m) therein.

Therefore, if the access count N(m) is more than the threshold value Nth, the CPU 101 sends a link change instruction signal to the one of the digital MFPs 20 to 40 corresponding to the apparatus name contained in the information concerning the shared document (m) via the LAN 90 (step S406). The link change instruction signal instructs the one of the digital MFPs 20 to 40 to change the linking method of the shared document from soft linking to hard linking. Simultaneously with sending of the link change instruction signal, the entity (duplicate) of the shared document (m) is sent.

Upon reception of the link change instruction signal, the one of the digital MFPs 20 to 40 stores the entity (duplicate) of the shared document (m) in an associated box based on the link change instruction signal. Simultaneously, the one of the digital MFPs 20 to 40 changes the linking method in the link information of the shared document (m) from soft linking to hard linking. Then, the one of the digital MFPs 20 to 40 returns a link change completion signal to the digital MFP 10.

Next, the CPU 101 of the digital MFP 10 awaits the link change completion signal from the digital MFPs 20 to 40 (step S407). If it is determined in the step S407 that the link change completion signal has been received, the CPU 101 rewrites the linking method of the shared document (m) in the access management table 110 into hard linking (step S408). Then, the CPU 101 increments the variable m by 1, and determines whether or not information concerning a next shared document (m) is recorded in the access management table 110 (step S409). If the information concerning the next shared document (m) is recorded in the access management table 110, the CPU 101 returns to the step S403. On the other hand, if no information concerning a next shared document (m) is recorded in the access management table 110, the CPU 101 terminates the present process.

If it is determined in the above step S405 that the access count N(m) is not more the threshold value Nth, the CPU 101 skips over the steps S406 to 408 to the step S409.

If it is determined in the step S404 that the linking method of the shared document (m) is hard linking, the CPU 101 determines whether or not the access count N(m) of the shared document (m) is not more than the threshold value Nth (step S410). In the present embodiment, the case where the access count N(m) is not more than the threshold value Nth is a case where one of the digital MPPs 20 to 40 corresponding to the apparatus name contained in the information concerning the shared document (m) accesses the shared document (m) using a hard link at a low frequency. In this case, the one of the digital MFPs 20 to 40 stores the entity (duplicate) of the shared document (m) in spite of the fact that it does not refer to the shared document frequently. This means that data which is not used frequently is stored in the HDD 104, and hence the HDD 104 is not efficiently used. Therefore, from the view point of efficient use of the HDD 104, it is preferable that the linking method by which the one of the digital MFPs 20 to 40 refers to the shared document (m) is changed from hard linking to soft linking.

Then, if the access count N(m) is not more than the threshold value Nth, the CPU 101 sends a link change instruction signal to the one of the digital MFPs 20 to 40 corresponding to the apparatus name contained in the information concerning the shared document (m) via the LAN 90 (step S411). The link change instruction signal sent at this time is for instructing one of the digital MFPs 20 to 40 to change the linking method of the shared document (m) from hard linking to soft linking.

The one of the digital MFPs 20 to 40 which has received the link change instruction signal changes the link information based on the link change instruction signal so as to change the linking method set for the shared document (m) from hard linking to soft linking. Then, the one of the digital MFPs 20 to 40 sends back a link change completion signal indicative of completion of changing the linking method of the shared document (m) to soft linking to the digital MFP 10.

Next, the CPU 101 of the digital MFP 10 waits for reception of the link change completion signal from the one of the digital MFPs 20 to 40 (step S412). If it is determined in the step S412 that the link change completion signal has been received, the CPU 101 rewrites the linking method of the shared document (m) in the access management table 110 into hard linking (step S413). Then, the CPU 101 increments the variable m by 1, and determines whether or not information concerning a next shared document (m) is recorded in the access management table 110 (step S409). If the information on the concerning the next shared document (m) is recorded in the access management table 110, the CPU 101 returns to the step S403. On the other hand, if no information concerning the next document (m) is recorded in the access management table 110, the CPU 101 terminates the present process.

If it is determined in the step S410 that the access count N(m) is not more than the threshold value Nth, the CPU 101 skips over the steps S411 to S413 to the step S409.

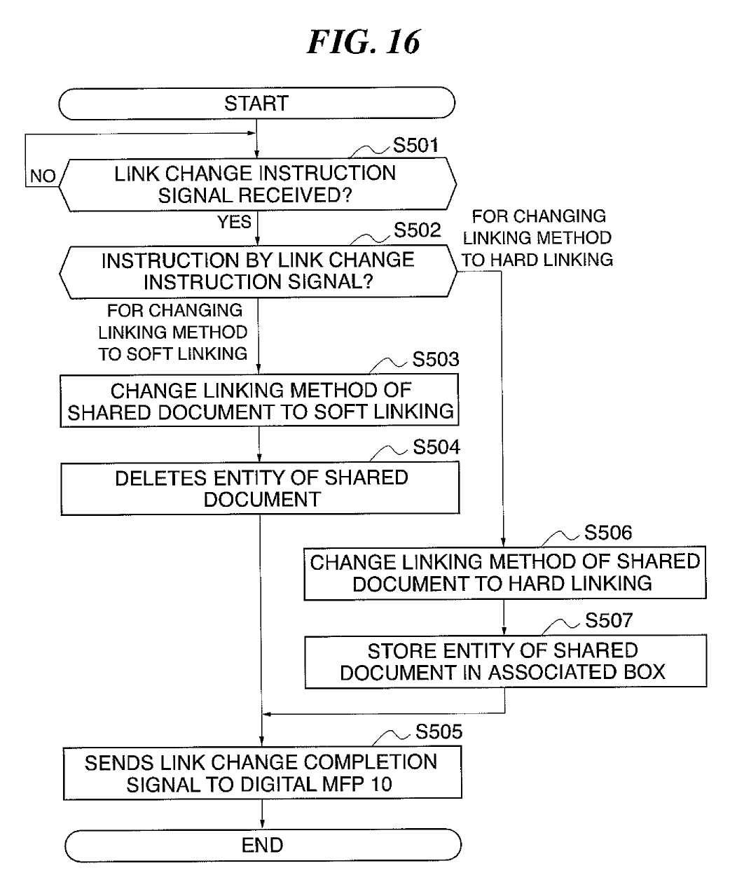

Next, a description will be given of a process in which one of the digital MFPs 20 to 40 changes the linking method based on the above-mentioned link change instruction signal, with reference to FIG. 16. FIG. 16 is a flowchart of the process in which the one of the digital MFPs 20 to 40 in FIG. 1 changes the linking method based on the link change instruction signal. The process of the FIG. 16 flowchart is executed by the CPU 101 of the one of the digital MFPs 20 to 40 according to a program stored in the ROM 103 thereof.

As shown in FIG. 16, the one of the digital MFPs 20 to 40 (the CPU 101 thereof) monitors reception of the link change instruction signal (step S501). If it is determined in the step S501 that that the link change instruction signal has been received, the one of the digital MFPs 20 to 40 determines an instruction of the link change instruction signal (step S502).

If it is determined here that the link change instruction signal is for changing the linking method to soft linking, the one of the digital MFPs 20 to 40 changes the linking method of the shared document in an associated box to soft linking (step S503). That is, the link information on the shared document is changed such that it corresponds to soft linking. Then, the one of the digital MFPs 20 to 40 deletes the entity of the shared document (step S504).

Next, the one of the digital MFPs 20 to 40 sends a link change completion signal indicating that the change of the linking method is completed, to the digital MFP 10 (step S505). Then, the one of the digital MFPs 20 to 40 terminates the present process.

If it is determined in the step S502 that the link change instruction signal is for changing the linking method to hard linking, the one of the digital MFPs 20 to 40 changes the linking method of the shared document in the associated box to hard linking (step S506). That is, the link information on the shared document is changed such that it corresponds to hard linking. Then, the CPU stores the entity (duplicate) of the shared document sent from the digital MFP 10, in the associated box (step S507).

Then, the CPU sends a link change completion signal indicating that the change of the linking method is completed to the digital MFP 10 (step S505). Then, the CPU 101 terminates the present process.

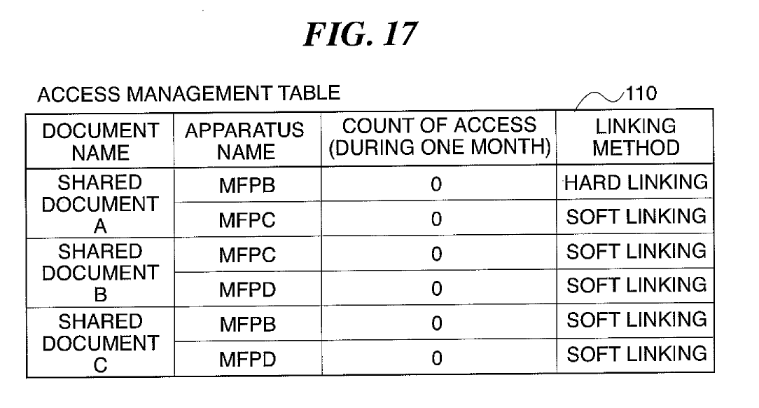

Next, a description will be given of an example of update of the access management table 110 in the case where the linking method is changed by the above-described linking method-changing process, with reference to FIG. 17. FIG. 17 is a view of an example of the update of the access management table in FIG. 11.

It is assumed here that the threshold value Nth with respect to the access count N is set to 5. Then, in the case of the linking method being soft linking, for each shared document the access count N of which is more than the aforementioned threshold value Nth, the linking method is changed to hard linking. Further, in the case of the linking method being hard linking, for each shared document the access count N of which is not more than the aforementioned threshold value Nth, the linking method is changed to soft linking.

For example, in the case of the access management table 110 shown in FIG. 11, as to the shared document A which the digital MFP 20 (MFPB) refers to using a soft link, the access count N (=10) exceeds the threshold value Nth (5). Therefore, as shown in FIG. 17, as to the shared document A which the digital MFP 20 refers to using the soft link, the linking method therefor is changed from soft linking to hard linking. Further, as to the shared document A which the digital MFP 30 (MFPC) refers to using a hard link, the access count N (=1) is not more than the threshold value Nth (=5). Therefore, as shown in FIG. 17, as to the shared document A which the digital MFP 30 refers to using the hard link, the linking method is changed from hard linking to soft linking.

As for the shared documents B and C, judging from the relationship between the access count N and the threshold value Nth, the linking method is not changed.

When the linking method-changing process is executed, the access count N is reset to 0 irrespective of whether the linking method has been changed or not.

Thus, according to the present embodiment, it is possible to change the linking method depending on the access count of (number of times of reference to) the shared document such that the time taken to refer to the shared document is reduced or the usage efficiency of the storage resource is improved.

In the present embodiment, the digital MFP 10, and the other digital MFPs 20, 30, and 40, which constitute the file system are described as an apparatus that stores the entity (original) of the shared document, and apparatuses that refer to the shared document, respectively. However, this is only by way of example, and each of the digital MFPs 10 to 40 can be a shared document-supplying side or a shared document-supplied side. In other words, all the digital MFPs 10 to 40 may each be an apparatus that is capable of executing the processes shown by the flowcharts in the embodiment.

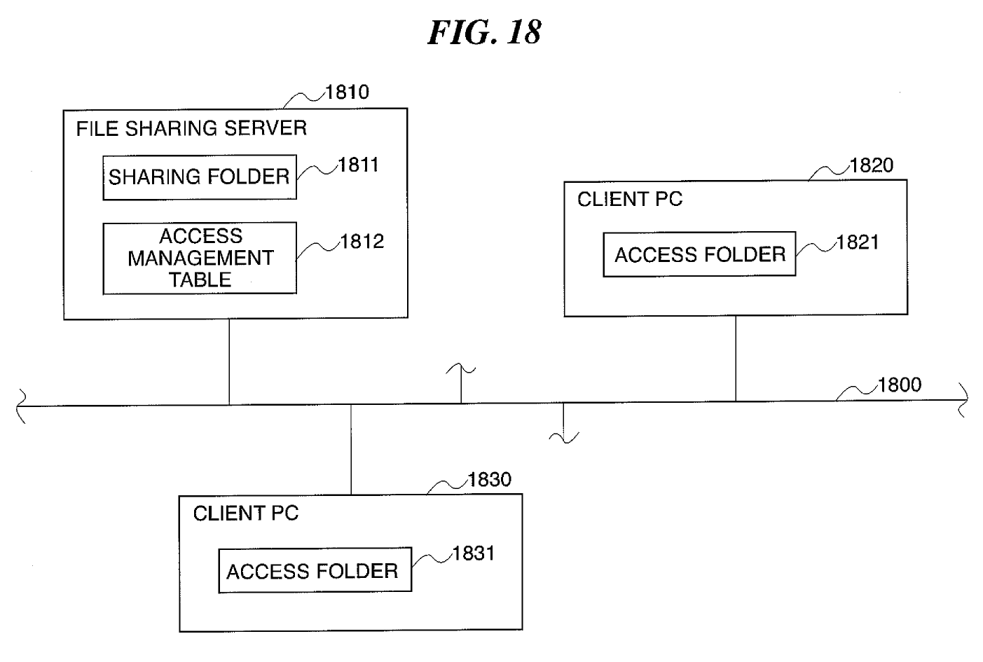

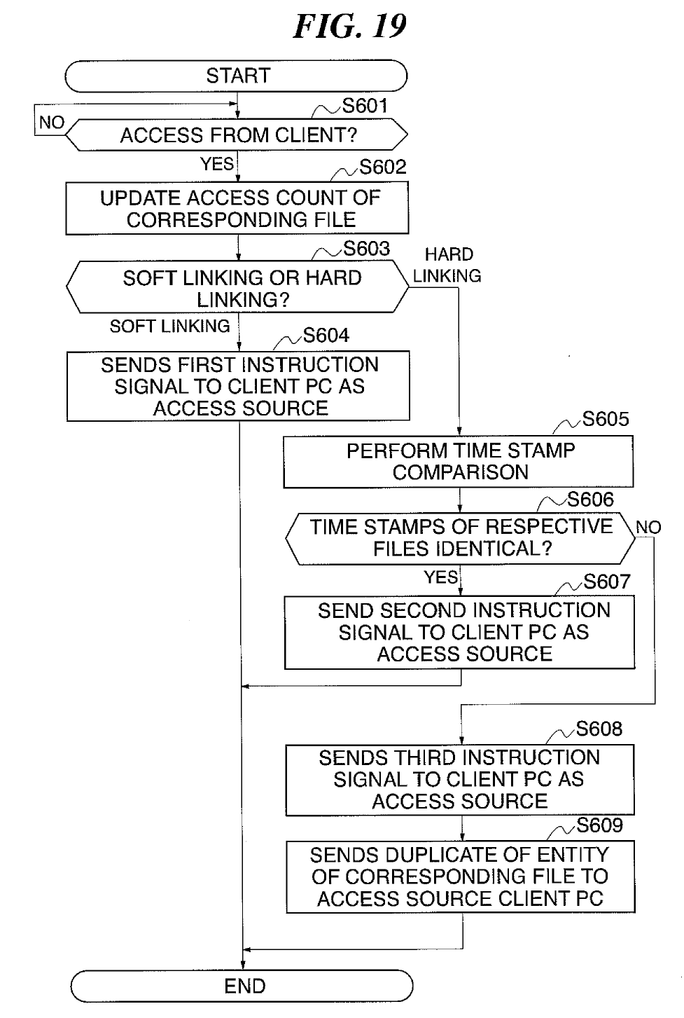

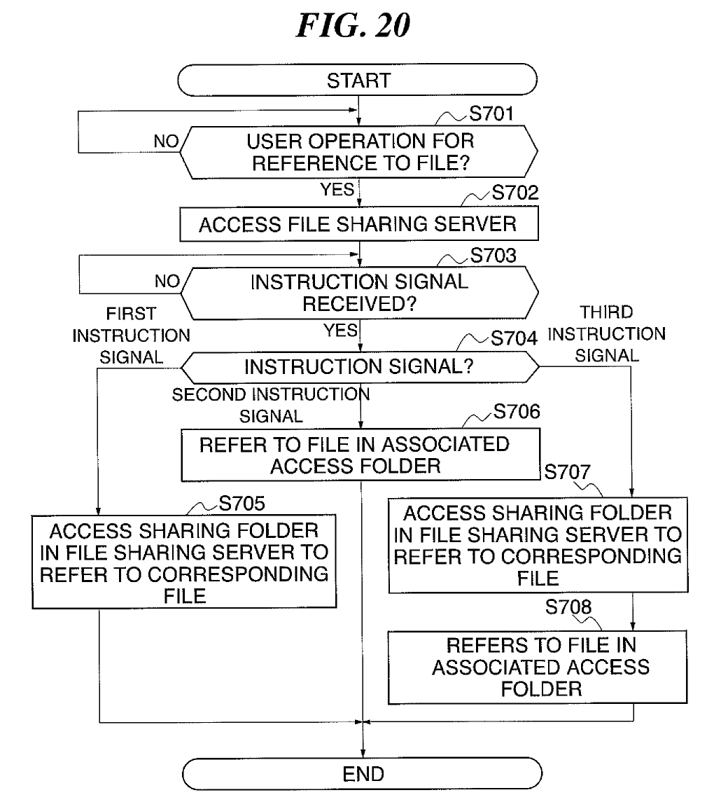

Next, a second embodiment of the present embodiment will be described with reference to FIGS. 18 to 20. FIG. 18 is a block diagram of a file system according to a second embodiment of the present invention. FIG. 19 is a flowchart of a process executed by a file sharing server 1810 when one of client PCs 1820 and 1830 appearing in FIG. 18 accesses the file sharing server 1810 so as to refer to a file in a sharing folder 1811 of the file sharing server 1810. FIG. 20 is a flowchart of a process executed by the one of the client PCs 1820 and 1830 in referring to a shared file.

In the present embodiment, a description will be given of a file system in which files stored in a file-sharing server (first apparatus) can be shared between information processing apparatuses (second apparatuses). More specifically, as shown in FIG. 18, the file system is comprised of the file sharing server 1810 (first apparatus) and the client PCs (personal computers) 1820 and 1830 (second apparatuses) connected to each other via a LAN 1800. The file sharing server 1810 has a sharing folder 1811 storing a plurality of files shared between the client PCs 1820 and 1830. Further, the file sharing server 1810 stores an access management table 1812, similarly to the first embodiment. The access management table 1812 is for managing the names of files in the sharing folder 1811, names of apparatuses having accessed the folders, the numbers of times (count) of access to the files, and the linking methods.

Each of the client PCs 1820 and 1830 is capable of referring to or downloading files in the sharing folder 1811 of the file sharing server 1810. Further, each of the client PCs 1820 and 1830 is capable of uploading a desired file into the sharing folder 1811.

In the illustrated example, similarly to the first embodiment, each of the client PCs 1820 and 1830 accesses a desired one of the files in the sharing folder 1811 of the file sharing server 1810 to thereby refer to the desired file. They each store access folders 1821 and 1831 for referring to the files.

For example, to refer to one of the files as shared documents from each of the client PCs 1820 and 1830, using a soft link, the entity of the file is not stored in one of the access folders 1821 and 1831 but link information for accessing the entity of the file is stored therein. For example, the file name, the linking method (soft link), the address information (IP address) of the file sharing server 1810 that stores the entity of the file, and folder information for specifying the sharing folder 1811, are stored as link information.

Further, to refer to one of the files from each of the client PCs 1820 and 1830 using a hard link, one of the access folders 1821 and 1831 stores the entity (duplicate) of the file, and link information for accessing the entity of the file. This is, as described hereinbefore, because the duplicate of the entity of the file is regarded as dependent data of the file, in the case of hard linking.

In each of the client PCs 1820 and 1830, the setting of a linking method for referring to the files in the sharing folder 1811 is carried out similarly to the first embodiment. The operation for the setting is performed using a user interface screen similar to that in the first embodiment, and a description thereof is omitted here.

Each of the client PCs 1820 and 1830 downloads information for implementing the linking method set by the above-described operation from the file sharing serer 1810, and stores the information in the access folders 1821 and 1831. Then, when each of the client PCs 1820 and 1830 refers to a file in the sharing folder 1811, it refers to the link information stored in the access folder 1821 or 1831 to access the file sharing server 1810. Further, the file sharing server 1810 registers the name of each file to be referred to from the one of the PCs 1820 and 1830, an apparatus name thereof, an access count, and a linking method in the access management table 1812, in association with each other. At this time, the access count is set to 0.

Then, a description will be given of a process executed by the file sharing server 1810 when one of the client PCs 1820 and 1830 accesses the file sharing server 1810 so as to refer to a file in the sharing folder 1811, with reference to FIG. 19. The process of the FIG. 19 flowchart is executed by a CPU, not shown, of the file sharing server 1810, according to a program stored in a ROM or HDD, not shown.

As shown in FIG. 19, first, the file sharing server 1810 (CPU thereof) monitors whether there is an access from any of the client PCs 1820 and 1830 on the LAN 1800 (step S601). This access is made by one of the client PCs 1820 and 1830 for referring to a file in the sharing folder 1811. When the access is made, information containing the apparatus name of an access source, the name of a file, and a linking method is sent from the one of the client PCs 1820 and 1830, and the file sharing server 1810 receives the information. Further, if the linking method is hard linking, the information contains a time stamp of the entity (duplicate) of the file stored in the corresponding one of the respective access folders 1821 and 1831 of the client PCs 1820 and 1830.

If there is an access from one of the client PCs 1820 and 1830, the file sharing server 1810 increments the access count associated with the file name included in the received information, in the access management table 1812, by 1 (step S602).

Next, the file sharing server 1810 determines whether or not the linking method included in the received information is soft linking or hard linking (step S603). If it is determined here that the linking method is soft linking, the file sharing server 1810 sends a first instruction signal instructing reference to the corresponding file in the sharing folder 1811 to the client PC as the access source (step S604). Then, the file sharing server 1810 terminates the present process.

If it is determined in the step S604 that the linking method is hard linking, the file sharing server 1810 performs a time stamp comparison (step S605). The time stamp comparison is made here between a time stamp contained in the received information (time stamp of the file in the associated one of the access folders 1821 and 1823) and a time stamp of the corresponding file in the file sharing folder 1811. Then, the file sharing server 1810 determines based on the result of the comparison whether the time stamps of the respective files agree with each other (step S606). This is for determining whether the entity (duplicate) of the file stored in the associated one of the access folders 1821 and 1831 is completely identical to the corresponding file (original) of the file in the sharing folder 1811. Assuming that the original was updated e.g. by a version upgrade, the original does not agree with the file (duplicate) stored in the associated one of the access folders 1821 and 1831.

If it is determined in the step S606 that the time stamps of the respective files agree with each other, the file sharing server 1810 sends a second instruction signal that instructs reference to the file in the associated access folder to the access source client PC (step S607). That is, the entity (duplicate) of the file stored in the associated one of the access folders 1821 and 1831 is quite identical with the corresponding file (original) in the sharing folder 1811 (not changed e.g. by a version upgrade). Therefore, the instruction for causing the one of the access source client PCs 1820 and 1830 to refer to the file in the associated one of the access folders 1821 and 1831. Then, the file sharing server 1810 terminates the present process.

If it is determined in the step S606 that the time stamps of the two files do not agree with each other, the file sharing server 1810 sends a third instruction signal for instructing reference to the file in the sharing folder 1811 to the access source client PC (step S608). This is because the entity (duplicate) of the file stored in the associated one of the access folders 1821 and 1831 is different from the corresponding file stored in the sharing folder 1811. Therefore, the one of the client PCs 1820 and 1830 as the access source is instructed to refer to the corresponding file in the sharing folder 1811.

Next, the file sharing server 1810 sends a duplicate of the entity of the corresponding file in the sharing folder 1811 to the access source client PC, in order to update the file stored in the associated access folder (step S609). Then, the file sharing server 1810 terminates the present process.

Thus, in the present embodiment, when referring to the file (duplicate) of a file shared using a hard link, it is confirmed whether the file is identical with the original by using the respective time stamps of the file and the original. This enables a client PC to refer to a file identical to the original even when the file (duplicate) stored in the associated one of the client PCs 1820 and 1830 is different from the file (original) stored in the file sharing server 1810.

This process can also be applied to the file system according to the first embodiment described above.

Next, a description will be given of a process in which a corresponding file is referred to from each of the client PCs 1820 and 1830, with reference to FIG. 20. The process of the FIG. 20 flowchart is executed by the CPU, not shown, of each of the client PCs 1820 and 1830, according to a program stored in the ROM or HDD, not shown, thereof.

As shown in FIG. 20, each of the client PCs 1820 and 1830 (CPU thereof) monitors whether the user has performed an operation for referring to a corresponding file using a soft link or a hard link (step S701). If the user of one of the client PCs 1820 and 1830 has performed the above-mentioned operation, the one of client PCs 1820 and 1830 accesses the file sharing server 1810 based on the link information in the associated one of the access folders 1821 and 1831, so as to refer to the file (step S702).

Then, the one of the client PCs 1820 and 1830 awaits reception of an instruction signal returned from the file sharing server 1810 in response to the above-mentioned access (step S703). Then, the one of the client PCs 1820 and 1830 determines which of the first to third instruction signals, the received signal is (step S704). As mentioned hereinbefore, the first instruction signal instructs reference to a file in the sharing folder 1811 in a case where the file is shared using a soft link. The second instruction signal instructs reference to a file in an access folder in a case where the file is shared using a hard link. The third instruction signal instructs reference to a file in the sharing folder 1811 in a case where the file is shared using a hard link.

If it is determined in the step S704 that the instruction signal is the first instruction signal, the one of the client PCs 1820 and 1830 accesses the file sharing server 1810 to refer to the corresponding file in the sharing folder 1811 (step S705). Then, the one of the client PCs 1820 and 1830 terminates the present process.

If it is determined in the step S704 that the instruction signal is the second instruction signal, the one of the client PCs 1820 and 1830 refers to the file in the associated one of the access folders 1821 and 1831 thereof (step S706). Then, the one of the client PCs 1820 and 1830 terminates the present process.

If it is determined in the step S704 that the instruction signal is the third instruction signal, the one of the client PCs 1820 and 1830 accesses the file sharing server 1810 to refer to the corresponding file in the sharing folder 1811 (step S707). Then, the one of the client PCs 1820 and 1830 replaces the entity of the file in the associated one of the access folders 1821 and 1831 by an entity of the file sent from the file sharing server 1810 (step S708). Then, the one of the client PCs 1820 and 1830 terminates the present process.

In the present embodiment, similarly to the first embodiment (process of the FIGS. 1SA and 15B flowchart), when a predetermined time period elapses, the file sharing server 1810 performs a process for changing linking methods recorded in the access management table 1812. More specifically, the file sharing server 1810 compares an access count and a threshold value thereof as to each of files recorded in the access management table 1812, and based on the result of the comparison, changes the linking method from soft linking to hard linking or from hard linking to soft linking. Further, when the linking method is changed, a link change instruction signal is sent to the one of the client PCs 1820 and 1830. Description of the process for changing the linking method in the present embodiment is omitted.

The one of the client PCs 1820 and 1830 changes the linking method in the link information stored in the associated one of the access folders 1821 and 1831 based on the link change instruction signal, similarly to the first embodiment (the process of the FIG. 16 flowchart). Description of the process for changing the linking method by the one of the client PCs 1820 and 1830 in the present embodiment is omitted.

Next, a third embodiment of the present invention will be described.

The present embodiment is an example of application of the present invention to a temporary storage file system for a Web browser. The Web browser generally has a temporary file function. The term “temporary file function” is intended to mean a function of temporarily storing data of a visited Web site, and using the data when accessing the same Web site again. The temporary file function enables the data to be displayed at high speed when the same Web site is visited.

The amount of storage of a disk for storing temporary files can be determined by user configuration. All data used when accessing a Web site are stored as temporary files, similarly to the cash system utilized in a memory system. When storing temporary files, if the predetermined amount of storage of the disk is exceeded, files are deleted oldest first by overwriting.

As for Web site browsing, sites to be visited are diverse, and there are a large number of sites temporarily visited. In this case, if the temporary file function of the conventional cash system is used, a temporary file storage folder for storing temporary files is occupied by information on sites temporarily accessed, and data of sites frequently accessed can be deleted.

The process for changing the linking method can be applied to the temporary file function, similarly to the first embodiment. This makes it possible to compare an access count and a threshold value thereof for each of items of data stored in the temporary file storage folder, and based on the result of the comparison, the linking method is changed from soft linking to hard linking or from hard linking to soft linking. As a result, data of frequently accessed sites can be stored in the temporary file storage folder, and data of temporarily accessed sites can be deleted.

Although in each of the above-described embodiments, an apparatus that supplies shared files stores an access management table, and instructs a change of the linking method, the file system may be configured such that apparatuses that access shared files may each store an access management table, and execute changing of the linking method. That is, each apparatus that accesses shared files may determine whether or not the number of times of access to each shared file during a predetermined time period is more than a threshold value, and depending on the result of the determination, a request of changing the linking method may be sent to an apparatus that is accessed.

It is to be understood that the present invention may also be accomplished by supplying a system or an apparatus with a storage medium in which a program code of software, which realizes the functions of each of the above described embodiments, is stored, and causing a computer (or CPU or MPU) of the system or apparatus to read out and execute the program code stored in the storage medium.

In this case, the program code itself read from the storage medium realizes the functions of each of the above described embodiments, and therefore the program code and the storage medium in which the program code is stored constitute the present invention.

Examples of the storage medium for supplying the program code include a floppy (registered trademark) disk, a hard disk, a magnetic-optical disk, optical disks, such as a CD-ROM, a CD-R, a CD-RW, a DVD-ROM, a DVD-RAM, a DVD-RW, and a DVD+RW, a magnetic tape, a nonvolatile memory card, and a ROM. Alternatively, the program may be downloaded via a network.

Further, it is to be understood that the functions of each of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of each of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2007-245214 filed Sep. 21, 2007, which is hereby incorporated by reference herein in its entirety.

What is claimed is:

1. A file system including a first apparatus that stores a file for reference, and a second apparatus that is connected to the first apparatus via a network, in which the file can be referred to from the second apparatus, comprising:
a linking method-setting unit configured to set, based on a user operation, a linking method for referring to the file stored in the first apparatus from the second apparatus, to one of a first linking method in which the file is directly accessed and referred to and a second linking method in which a duplicate of the file stored in the second apparatus is referred to; and
a linking method-changing unit configured to change the one of the first and second linking methods set as the linking method to the other of the first and second linking methods, according to frequency of reference from the second apparatus to the file.

2. A file system as claimed in claim 1, further comprising an access management unit configured to manage a count of reference to the file from the second apparatus during a predetermined time period,
wherein said linking method-changing unit changes the one of the first and second linking methods set as the linking method to the other of the first and second linking methods depending on the count of reference to the file during the predetermined time period.

3. A file system as claimed in claim 2, wherein said management unit manages the count of reference to the file from the second apparatus, using the linking method set by said linking method-setting unit, during the predetermined time period.

4. A file system as claimed in claim 2, wherein when the set linking method is the first linking method, said linking method-changing unit determines whether or not the count of reference to the file is more than a predetermined threshold value, and if it is determined that the count of reference to the file is more than the predetermined threshold value, said linking method-changing unit changes the set linking method to the second linking method.

5. A file system as claimed in claim 2, wherein when the set linking method is the second linking method, said linking method-changing unit determines whether or not the count of reference to the file is not more a predetermined threshold value, and if it is determined that the count of reference to the file is not more than the predetermined threshold value, said linking method-changing unit changes the set linking method to the first linking method.

6. A file system as claimed in claim 4, wherein when the set linking method is changed to the second linking method by said linking method-changing unit, a duplicate of the file is stored in the second apparatus.

7. A file system as claimed in claim 5, wherein when the set linking method is changed to the first linking method by said linking method-changing unit, a duplicate of the file stored in the second apparatus is deleted.

8. A file system as claimed in claim 2, comprising a determination unit configured to determine, when the linking method set by the user is the second linking method, whether the file stored in the first apparatus and a duplicate of the file stored in the second apparatus are identical to each other, before referring to the duplicate of the file stored in the second apparatus, and
wherein when it is determined that the file stored in the first apparatus and the duplicate of the file stored in the second apparatus are not identical to each other, the second apparatus accesses the file stored in the first apparatus, and after referring to the file, stores a duplicate of the file sent from the first apparatus.

9. A data processing apparatus, comprising:
a setting unit configured to set a linking method by which a file stored in another apparatus is referred to from the data processing apparatus to one of a first linking method in which the file is referred to by directly accessing the file, and a second linking method in which a duplicate of the file stored in the data processing apparatus is referred to; and
a change unit configured to change the one of the first and second linking methods set as the linking method to the other of the first and second linking methods, according to frequency of reference from the second apparatus to the file.

10. A file reference method of referring to a file stored in a first apparatus for reference from a second apparatus connected to the first apparatus via a network, comprising:
a linking method-setting step of setting, based on a user operation, a linking method by which the file stored in the first apparatus is referred to from the second apparatus, to one of a first linking method in which the file is directly accessed and referred to and a second linking method in which a duplicate of the file stored in the second apparatus is referred to; and
a linking method-changing step of changing the one of the first and second linking methods set as the linking method to the other of the first and second linking methods, according to frequency of reference from the second apparatus to the file.

11. A storage medium storing a program for causing a computer to execute a file reference method of referring to a file stored in a first apparatus from a second apparatus connected to the first apparatus via a network, in a computer-readable manner,
wherein the file reference method comprises:
a linking method-setting step of setting, based on a user operation, a linking method by which the file stored in the first apparatus is referred to from the second apparatus, to one of a first linking method in which the file is directly accessed and referred to and a second linking method in which a duplicate of the file stored in the second apparatus is referred to; and
a linking method-changing step of changing the one of the first and second linking methods set as the linking method to the other of the first and second linking methods, according to frequency of reference from the second apparatus to the file.
